(19) United States
(12) Patent Application Publication
(10) Pub. No.: US 2002/0089466 A1
(43) Pub. Date: Jul. 11, 2002

(54) Antenna mast mounting system

(76) Inventors: William L. Magee, Cherry Hill, NJ (US); Brian J. MacNichol, Doylestown, PA (US)

Correspondence Address: Alex R. Sluzas, Esq., PAUL & PAUL, 2900 Two Thousand Market Street, Philadelphia, PA, 19103, US

(21) Appl. No.: 09/755,262

(22) Filed: Jan. 5, 2001

Related U.S. Application Data
(60) Provisional application No. 60/213,649, filed on Jun. 23, 2000.

(51) Int. Cl. H01Q 1/12

(52) U.S. Cl. 343/890

(57) ABSTRACT

A two-component antenna mast mounting system designed for installation onto a wooden pole and providing for support for telephone communications antennas. The mast mounting system including an upper and lower section. The lower section provides for a level surface, and the upper section provides for the support for the antennas.

### CROSS-REFERENCE TO RELATED APPLICATIONS

This application claims the benefit of U.S. Provisional Patent Application, No. 60/213,649, Filed Jun. 23, 2000.

### BACKGROUND OF THE INVENTION

1. Field of the Invention

The present invention relates to systems for mounting communications antennas, and in particular systems for mounting communications antenna on top of wooden poles.

2. Brief Description of the Prior Art

With the increase in telecommunication networks, and in particular cellular phone systems, there has been a corresponding increase in number of geographically dispersed transmitting and receiving stations including antennas. Positioning and mounting suitable antennas present a number of problems. Among these is the problem of mounting an array of communications antennas high above ground level, so that good quality transmission and reception can be provided to mobile users, while simultaneously aligning the antenna array as an element of a communications grid. One attempted solution to this problem has been to mount communications antenna arrays on top of preexisting wooden utility poles. The preexisting poles are ubiquitous, are easily accessible, and frequently provide the highest local sites. On the other hand, the poles are frequently only nominally vertical, and tend to lean at unpredictable angles. This makes alignment of the antenna array difficult. Alignment typically has taken place after the initial installation of the antenna array, and has required a survey crew to direct an individual perched atop the pole to rotate and position the antenna array accurately in respect of local reference points. Moreover, prior art, ad hoc methods for mounting communications antennas on top of utility poles frequently result in unattractive, visually jarring installations. There is a need for a simplified method for installing communication antennas on top of wooden utility poles in an aesthetically pleasing manner.

### SUMMARY OF THE INVENTION

The present invention provides an antenna mast mounting system for securing an antenna, such as a telephone communications antenna, to the top of a pole, such as a preexisting wooden telephone pole. The present invention also provides a method for installing an antenna on top of a pole at a predetermined orientation.

The antenna mast mounting system of the present invention comprises an upper section including a generally vertical mast, at least one means for attaching at least one antenna to the mast, and a base plate. The mast extends upwardly from the base plate. The mounting system also includes a lower section that includes a cap, at least two legs, and preferably three legs, extending downwardly from the cap; and means for securing the at least two legs to the pole. The antenna mast mounting system also includes means for securing the upper section to the lower section, such as bolts.

Preferably, the base plate of the upper section includes a first set of mounting apertures formed in the base plate, while the cap of the lower section has an upper plate with a second set of mounting apertures formed in the upper plate. The base plate is generally parallel to the upper plate when the upper section is secured to the lower section. Preferably, the first set of apertures are positioned at a fixed radius from the center of the base plate, and the second set of apertures are positioned at the same fixed radius from the center of the upper plate.

It is preferred that the number of apertures in the first set does not equal the number of apertures in the second set. Preferably, the upper section is rotatably alignable with the lower section such that at least three of the apertures in the first set are simultaneously alignable with at least three respective apertures in the second set. This can be accomplished when the number of apertures in one of the two sets of apertures (for example the upper plate) is 15 and the number of apertures in the second set of apertures (i.e. the base plate when the upper plate has 15 apertures) is 18. Preferably, the means for securing the upper section to the lower section comprises at least two fastening means, such as bolts, each fastening means extending through one of the first set of mounting apertures and a respective one of the second set of mounting apertures.

Preferably, the at least one means for attaching at least one antenna to the mast includes a first set of extending arms, preferably comprising three lower extending arms, and the three lower extending arms are equally angularly spaced around the mast. Preferably, the at least one means for attaching at least one antenna to the mast also includes a second set of extending arms, which also comprise three upper extending arms, the three upper extending arms also being equally angularly spaced around the mast, and preferably aligned with the lower extending arms.

The present invention also provides a method for installing an antenna on top of a wood pole at a predetermined orientation using the antenna mounting system. The method comprises the steps of mounting a lower section on top of the pole with the lower section being aligned to the predetermined orientation. This can be accomplished using a standard survey technique employing the known location of a fixed starting point or datum. A transit, such as a laser-equipped transit is placed at the datum and focused on the lower section.

An object of the present invention is to provide an antenna mast mounting system, which can fully support telephone communications antenna.

Another object of the present invention is to provide an antenna mast mounting system, which is visually pleasing with rest of the landscape.

A further object of the present invention is to provide a two-component antenna mast mounting system, which allows for better control and adjustment of the antennas when necessary.

Yet another object of the present invention is to provide an antenna mast mounting assembly, which will level the top of a wooden pole, thus allowing for antennas to be mounted in a substantially straight and vertical manner.

Still another object of the present invention is to provide for an antenna mast mounting assembly, which will protect the antenna wires by allowing them to run down the pole under a protective mounting structure.

These and other objects of the present invention will become more readily apparent when taken into consideration with the following description and the attached drawings.

### BRIEF DESCRIPTION OF THE DRAWINGS

FIG. 1 is a side elevational view of an antenna mast mounting system of the present invention.

FIG. 2 is a side elevational view of the antenna mast mounting system of FIG. 1, shown with three sets of antennas attached.

FIG. 3 is a top plan sectional view of the upper section of the antenna mast mounting system of FIG. 1, as taken from the line 3-3 of FIG. 1.

FIG. 4 is a top plan sectional view of upper section taken along the line 4-4 of FIG. 1.

FIG. 5 is a broken side elevational view of the mast of the upper section of the antenna mast mounting system of FIG. 1 shown before assembly.

FIG. 6 is a partial side elevational view of the mast of the upper section of the antenna mast mounting system of FIG. 1 showing a mounting bracket for an arm.

FIG. 7 is a top plan view of the upper plate of the cap of the lower section of the antenna mast mounting system of FIG. 1.

FIG. 8 is a side elevational view of the lower section of the antenna mast mounting system of FIG. 1.

FIG. 9 is a sectional view of the lower section of the antenna mast mounting system of FIG. 1 taken along the line 9-9 of FIG. 8.

### DETAILED DESCRIPTION OF THE DRAWINGS

Referring now to the drawings in detail, wherein like reference numerals indicate like elements throughout the several views, there is shown in FIG. 1 an antenna mast mounting system 10 comprising an upper section 20 and a lower section 70 (best seen in FIG. 8). In installing the antenna mounting system 10, the lower section 70 is first positioned on top of the selected pole 100, leveled and oriented. The lower section 70 is then securely attached to the top of the pole 100 using a plurality of fasteners such as bolts 92. The upper section 20 is then positioned on top of the lower section 70, oriented, and securely fastened to the lower section 70 using a suitable plurality of fasteners 46.

The upper section 20 comprises a mast 22 extending vertically upwards from a base plate 40 securely attached to the bottom of the mast 22. A plurality of generally triangular support plates 44 are secured to the top of the base plate 40 to provide support for the mast 22, best seen in FIG. 5.

The upper plate 80 includes a plurality of holes 82 positioned at a fixed radius from the center, and equally angularly spaced around the center, for attaching the upper section 20 to the lower section 70 after the lower section 70 has been mounted on the top of a telephone pole 100. In the embodiment shown, 18 holes 82 are formed in the upper plate.

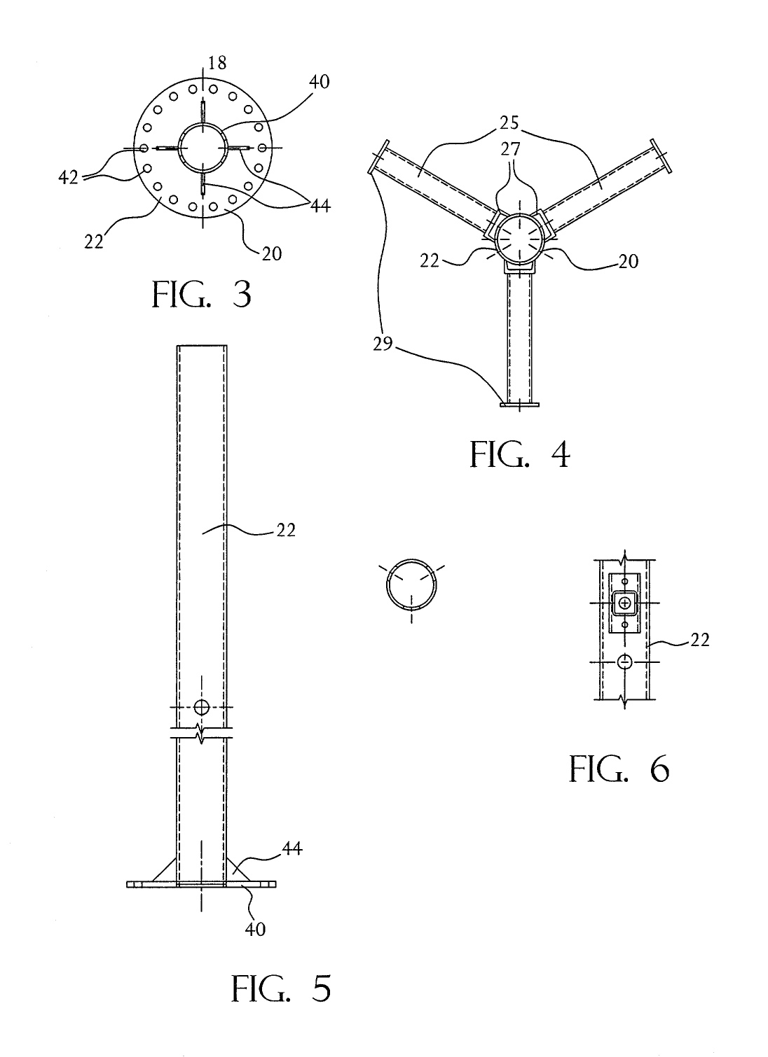

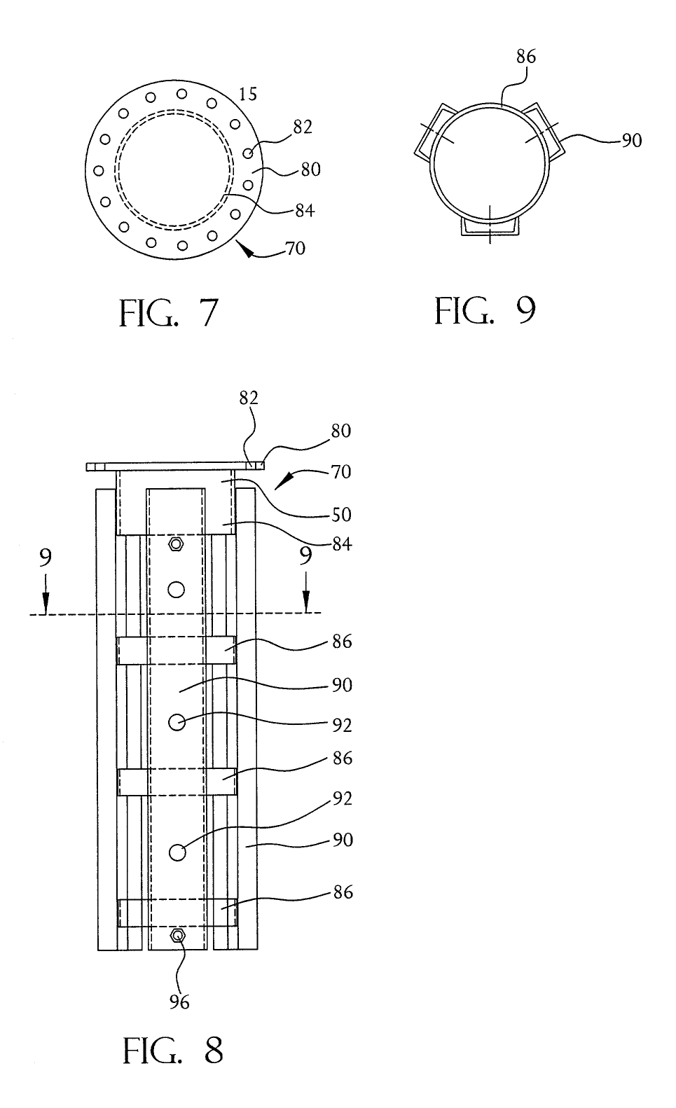

FIG. 3 is a sectional view of the mast 22 of the upper section 20. At least four support plates 44 are shown to provide a rigid connection between the base plate 40 and the mast 22. A plurality of mounting holes 42 are shown formed in the base plate 40 and positioned at a fixed radius from the mast 22, and equally angularly spaced around the mast 22. In the present embodiment 15 mounting holes are formed in the base plate 40.

The upper plate 80 and the base plate 40 are preferably placed such that three mounting holes 82 in the upper plate 80 align with three mounting holes 42 in the base plate 40 when the upper section 20 is mounted on the lower section 70.

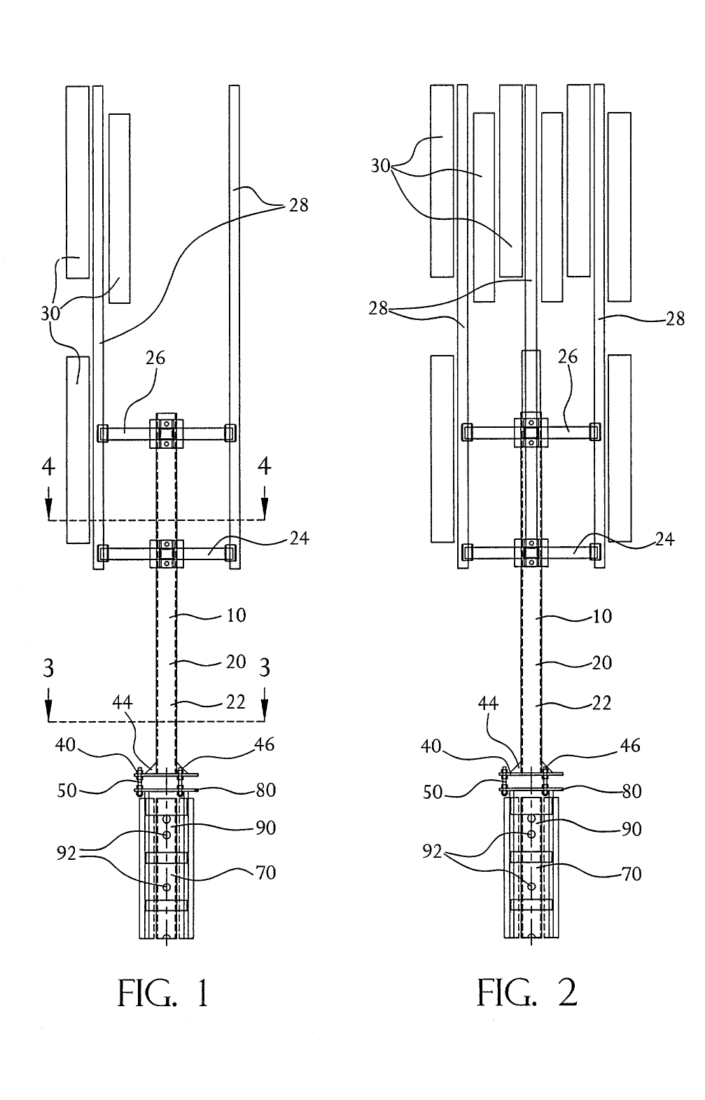

As can be seen in FIG. 1, the upper section 20 further includes two identical sets of extending arms 24, 26. As best seen in the sectional view of FIG. 4, the first of the identical sets, a lower set 24, comprises three lower extending spider arms 25. The spider arms 25 are arranged in an equally angular position, such that each arm 25 is spaced 120° from the other two arms 25. The spider arms 25 are fixably secured with spider arm channels 27 to the mast 22 of the upper section 20. The spider arms 25 terminate with spider arm end plates 29 at the ends of the spider arms 25. The extending arms 24, 26 are aligned for mounting legs 28 to the respective end plates 29. Communications antennae 30 are secured to the mounting legs, as shown in FIGS. 1 and 2.

A mounting leg 28 is attached to respective pairs of end plates 29, such that the bottom of each leg 28 attaches to a first respective spider arm end plate 29, with a portion of the leg 28 being attached to a second respective spider arm end plate 29. Communications antennas 30 are attached to the mounting legs 28 such that at least one antenna 30 can be attached to a lower portion of the mounting leg 28, while at least two antennas 30 can be attached to an upper portion of the mounting leg 28.

As best seen in the side elevational view of FIG. 8, the lower section 70 comprises a cap 50, which includes an upper plate 80, which is shown connecting the top of the lower section 70 to the upper section 20. At least two legs 90, preferably formed from channel stock extend downwardly from the cap 50 and are secured to the wooden pole 100. The cap 50 further comprises a circular upper plate 80 and a cylindrical upper tube segment 84. The lower section 70 includes a plurality of pole mounting holes 92 for mounting onto the top of a pole, such as a wooden telephone pole 100.

The channel stock from which the legs 90 is formed provide space for the antenna wires (not shown) to run down the wooden pole 100, such that the antenna wires (not shown) are not exposed directly to the outside of the mounting system, contributing to a neat and attractive appearance.

The present invention also provides a communications transmitting system comprising the antenna mounting system described above, associated antennas, a source of a radio frequency communications signal, means for connecting such antennas to the source. The present invention provides a process for transmitting a radio frequency communications signal comprising providing a signal to the radio frequency communications source, and transmitting the signal through the antennas mounted as described above.

These and other advantages of the present invention will be understood by a reading of the Summary of the Invention, the Brief Description of the Drawing Figures and the Detailed Description of the Preferred Embodiments.

What is claimed is:

1. An antenna mast mounting system for securing an antenna to the top of a pole, the antenna mast mounting system comprising:
(a) an upper section comprising
a generally vertical mast;
at least one means for attaching at least one antenna to the mast; and
a base plate, the mast extending upwardly from the base plate;
(b) a lower section comprising
a cap;
at least two legs extending downwardly from the cap; and
means for securing the at least two legs to the pole; and
(c) means for securing the upper section to the lower section.

2. An antenna mast mounting system according to claim 1 wherein the base plate of the upper section has a center and includes a first set of mounting apertures formed in the base plate, the cap of the lower section having an upper plate having a center and a second set of mounting apertures formed in the upper plate, the base plate being generally parallel to the upper plate when the upper section is secured to the lower section.

3. An antenna mast mounting system according to claim 2 wherein the first set of apertures are positioned at a fixed radius from the center of the base plate, the second set of apertures being positioned at the fixed radius from the center of the upper plate.

4. An antenna mast mounting system according to claim 3 wherein the number of apertures in the first set does not equal the number of apertures in the second set, and wherein the upper section is rotatably alignable with the lower section such that at least three of the apertures in the first set are simultaneously alignable with at least three respective apertures in the second set.

5. An antenna mast mounting system according to claim 4 wherein the number of apertures in one of the two sets of apertures is 15 and the number of apertures in the second set of apertures is 18.

6. An antenna mast mounting system according to claim 1 wherein the means for securing the upper section to the lower section comprising at least two fastening means, each fastening means extending through one of the first set of mounting apertures and a respective one of the second set of mounting apertures.

7. An antenna mast mounting system according to claim 1 wherein the at least one means for attaching at least one antenna to the mast includes a first set of extending arms.

8. An antenna mast mounting system according to claim 7 wherein the first set of extending arms comprise three lower extending arms, the three lower extending arms being equally angularly spaced around the mast.

9. An antenna mast mounting system according to claim 1 wherein the at least one means for attaching at least one antenna to the mast includes a second set of extending arms.

10. An antenna mast mounting system according to claim 9 wherein the second set of extending arms comprises three upper extending arms, the three upper extending arms being equally angularly spaced around the mast.

11. A method for installing an antenna on top of a wood pole at a predetermined orientation, the method comprising:
(a) mounting a lower section on top of the pole, the lower section being aligned to the predetermined orientation, and
(b) mounting an upper section on top of the lower section, the upper section comprising at least one antenna.

12. The method according to claim 11 wherein
(a) the upper section comprises
a generally vertical mast;
at least one means for attaching the at least one antenna to the mast; and
a base plate, the mast extending upwardly from the base plate; and
(b) the lower section comprises
a cap;
at least two legs extending downwardly from the cap; and
means for securing the at least two legs to the pole.

13. The method according to claim 12 wherein the base plate of the upper section has a center and includes a first set of mounting apertures formed in the base plate, the cap of the lower section having an upper plate having a center and a second set of mounting apertures formed in the upper plate.

14. The method according to claim 13 wherein the first set of apertures are positioned at a fixed radius from the center of the base plate, the second set of apertures being positioned at the fixed radius from the center of the upper plate.

15. The method according to claim 14 wherein the number of apertures in the first set does not equal the number of apertures in the second set, and wherein the upper section is rotatably alignable with the lower section such that at least three of the apertures in the first set are simultaneously alignable with at least three respective apertures in the second set, the method further comprising rotatably aligning the upper section with the lower section such that at least three of the apertures in the first set are each aligned with a respective aperture in the second set.

16. The method according to claim 15 wherein the number of apertures in one of the two sets of apertures is 15 and the number of apertures in the second set of apertures is 18.

17. The method according to claim 15 further comprising securing the upper section to the lower section with a fastening means installed in at least three of the aligned apertures.
